(19) United States
(12) Patent Application Publication
(10) Pub. No.: US 2007/0250875 A1
(43) Pub. Date: Oct. 25, 2007

(54) Methods, apparatuses, and computer program products for delivering one or more television programs for viewing during a specified viewing interval

(76) Inventor: Timothy H. Weaver, Alpharetta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/511,012

(22) Filed: Aug. 28, 2006

Related U.S. Application Data
(60) Provisional application No. 60/711,884, filed on Aug. 26, 2005.

(51) Int. Cl. H04N 7/173; G06F 3/00; H04N 5/445

(52) U.S. Cl. 725/89; 725/87; 725/86; 725/61

(57) ABSTRACT

Methods, apparatuses, and computer program products for delivering one or more television programs for viewing during a specified viewing interval. The methods include receiving a viewer's selection of a broadcast channel from an electronic program guide, presenting the viewer with a list or menu of two or more programs on the viewer selected broadcast channel that are available for viewing during a specified viewing interval, and receiving a viewer's selection of a program from the list or menu. If the specified viewing interval has commenced and has not yet expired, the viewer selected program is delivered for viewing.

### RELATED CASES

This application is based upon and claims priority under 35 USC §119(e) to Provisional Patent Application Ser. No. 60/711,884 filed on Aug. 26, 2005, the disclosure of which is incorporated herein in its entirety.

### BACKGROUND OF THE INVENTION

The present invention relates generally to delivery of media content in connection with a wide area data network and, more particularly, to methods, apparatuses, and computer program products for delivering one or more television programs for viewing during a specified viewing interval.

Delivering media content over a wide area data network is an increasingly popular method of transmitting audiovisual programs to viewers, enabling service providers to offer programming much more efficiently than in the case of traditional cable television systems. Internet protocol television (IPTV) represents one illustrative approach for delivering media content over a network. IPTV is ideal for programs intended for use by only a few subscribers, because a minimum amount of network resources are tied up to service this need. In contrast to broadcast television, IPTV has no inherent limitation on the total number of channels that can be offered for transmission. As a practical matter, the number of channels that can be carried to IPTV subscribers is significantly higher relative to traditional video delivery systems, limited only by the overall capacity of the network and the portion of the network which is allocated to IPTV services. Moreover, the same data transmission capacity of a network can be used for IPTV as well as other types of data traffic.

Television programs carried by over-the-air broadcast stations and cable channels are typically scheduled to take place during one or more predetermined timeslots. If a viewer wishes to watch a program but is unable to do so during the scheduled timeslot, the viewer has the option of programming a video recording device in advance of the scheduled timeslot. Examples of video recording devices include video cassette recorders (VCRs), digital video disk (DVD) recorders, and hard drive recording devices. Not infrequently, the viewer forgets to program the video recording device, thereby missing a favorite television program.

Even if a viewer remembers to program his or her recording device in advance of the scheduled timeslot, the programming process is often tedious and error-prone. Moreover, under some circumstances, existing recording devices are not able to address situations where a viewer wishes to watch two or more television programs in a sequence other than that in which the programs are broadcast. For example, a television network has scheduled a one-hour situation comedy program for broadcast at 9:00 PM on Monday evening, followed by a one-hour mystery series at 10:00 PM. However, a viewer wishes to watch the mystery series at 9:00 PM on Monday evening, followed by the situation comedy at 10:00 PM. Using current approaches, the viewer could record one or both of these program on a digital video recorder (DVR), video cassette recorder (VCR), or computer data storage drive, but even so it would be impossible for the viewer to view the two aforementioned programs in the desired sequence starting at 9:00 PM. Accordingly, what is needed is a mechanism by which a viewer can view one or more broadcast programs during a specified time interval in the sequence they prefer.

### BRIEF SUMMARY OF THE INVENTION

Exemplary embodiments include methods for delivering one or more television programs for viewing during a specified viewing interval. These methods include receiving a viewer's selection of a broadcast channel from a program guide, presenting the viewer with a list or menu of two or more programs on the viewer selected broadcast channel that are available for viewing during a specified viewing interval, and receiving a viewer's selection of a program from the list or menu. If the specified viewing interval has commenced and has not yet expired, the viewer selected program is delivered for viewing.

Additional exemplary embodiments include apparatuses for delivering one or more television programs for viewing during a specified viewing interval. These apparatuses include an input mechanism for accepting a viewer's selection of a broadcast channel from a program guide, an electronic display operatively coupled to the input mechanism for displaying a list or menu of two or more programs on the viewer selected broadcast channel that are available for viewing during a specified viewing interval, and a processing mechanism for controlling the electronic display and for accessing a computer readable storage medium. The input mechanism is capable of receiving a viewer's selection of a program from the displayed list or menu. If the specified viewing interval has commenced and has not yet expired, the processing mechanism delivers the viewer selected program for viewing.

Further exemplary embodiments include computer program products for establishing a trusted network. The computer program products comprise a storage medium readable by a processing circuit and storing instructions for execution by the processing circuit for facilitating a method of delivering one or more IPTV television programs for viewing during a specified viewing interval. The method includes receiving a viewer's selection of an IPTV broadcast channel from an electronic program guide, presenting the viewer with a list or menu of two or more programs on the viewer selected IPTV broadcast channel that are available for viewing during a specified viewing interval, and receiving a viewer's selection of a program from the list or menu. If the specified viewing interval has commenced and has not yet expired, the viewer selected program is delivered for viewing.

Other methods, apparatuses, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system that may be utilized for delivering one or more television programs for viewing during a specified viewing interval.

FIG. 2 is a flow diagram of a first exemplary process for delivering one or more television programs for viewing during a specified viewing interval.

FIGS. 3A and 3B together comprise a flow diagram of an exemplary network-based process for delivering one or more television programs for viewing during a specified viewing interval.

FIGS. 4A and 4B together comprise a flow diagram of an exemplary premises-based process for delivering one or more television programs for viewing during a specified viewing interval.

FIG. 5 is an illustrative electronic program guide showing a list or menu of one or more television programs that are available for viewing on a selected channel during a specified viewing interval.

The detailed description explains the exemplary embodiments, together with advantages and features, by way of example with reference to the drawings.

### DETAILED DESCRIPTION OF EXEMPLARY EMBODIMENTS

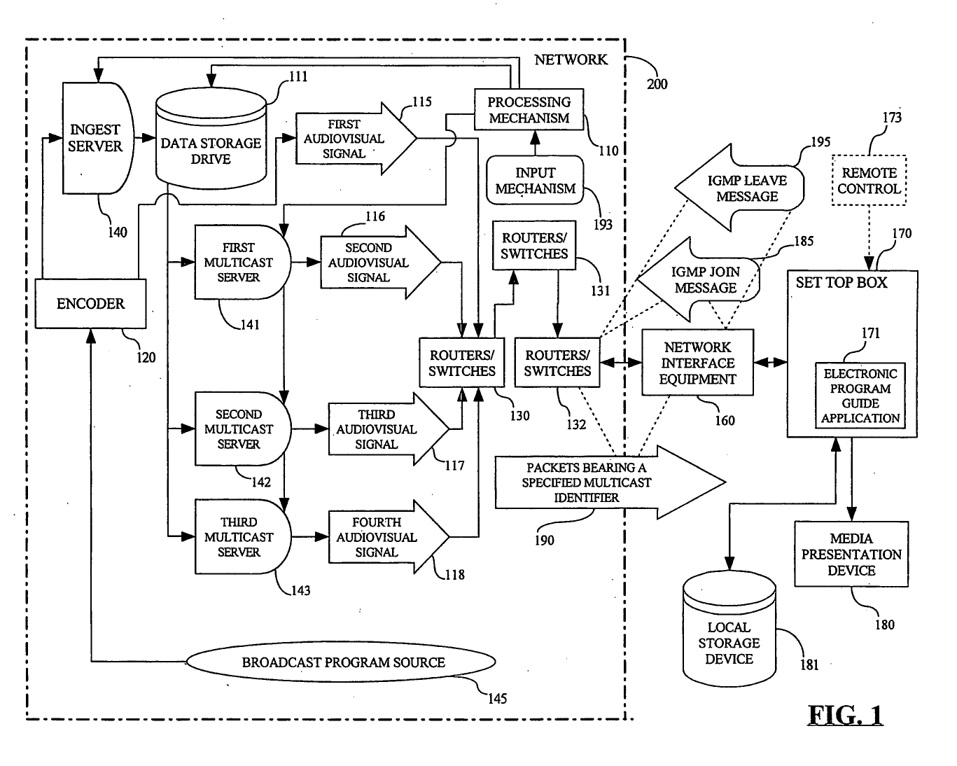

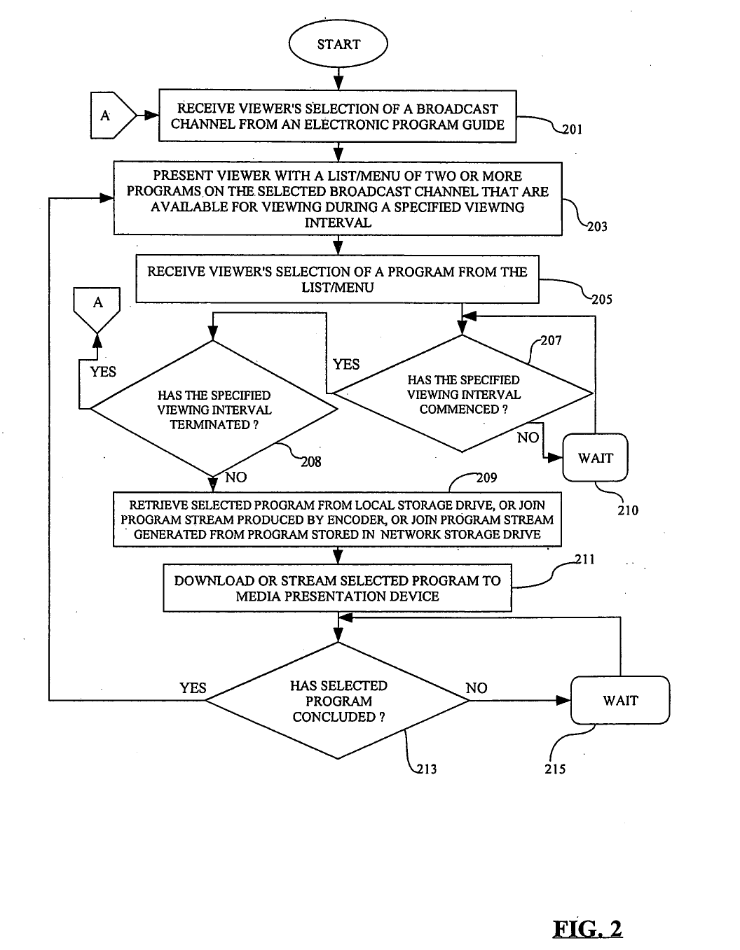

FIG. 1 is a block diagram of an exemplary system that may be utilized for delivering one or more television programs for viewing during a specified viewing interval. A wide area data network 200 may include a broadcast program source 145 operatively coupled to an encoder 120. Broadcast program source 145 may be implemented using a satellite receiver, cable television head end, terrestrial broadcast receiver, fiber optic links to one or more television broadcast stations, or various combinations thereof. Encoder 120 processes each of one or more respective television signals acquired by broadcast program source 145 to generate a corresponding sequence of packets. The sequence of packets is in a digital format compatible with internet protocol (IP) networking.

Optionally, the sequence of packets generated by encoder 120 may be compressed or processed to eliminate redundant information, thereby reducing the bandwidth occupied by one or more of the program streams. For example, digital video transmission methods currently employ standards developed by the Motion Pictures Expert Group (MPEG) for program stream formatting and network transport. These standards, known collectively as MPEG, define approaches for compressing video content to significantly reduce the bandwidth required for network transport. MPEG compression creates a stream of individual packets or frames, each carrying video content. Illustratively, the sequence of packets generated by encoder 120 is in a packetized format that complies with MPEG-4 standard H.264.

Encoder 120 may generate a first multicast program stream including a television program commencing at a scheduled broadcast time. This first multicast program stream is shown as a first audiovisual signal 115. An ingest server 140, illustratively implemented using one or more computer servers, is operatively coupled to encoder 120. Ingest server 140 may receive the first multicast program stream and processes the stream for storage on a computer-readable television program storage device such as data storage drive 111. Data storage drive 111, operatively coupled to ingest server 140, may electronically store a television program for one or more subsequent rebroadcasts. Data storage drive 111 is illustratively implemented using one or more computer hard drives, optical storage drives, magnetic tape drives, semiconductor memory, nanotechnology-based memory devices, or various combinations thereof. By way of example, a plurality of separate storage drives may be interconnected or networked to implement data storage drive 111.

Data storage drive 111 is operatively coupled to one or more multicast servers such as a first multicast server 141, a second multicast server 142, and a third multicast server 143. First, second, and third multicast servers 141, 142, 143 are illustratively implemented using computer servers. Illustratively, one or more of the first, second, and third multicast servers 141, 142, 143 may be implemented using a single server. Pursuant to another illustrative example, one or more of the first, second, and third multicast servers 141, 142, 143 are implemented using a plurality of servers.

A processing mechanism 10 is operatively coupled to data storage drive 111, ingest server 140, and at least one multicast server. In the present example, first, second, and third multicast servers 141, 142, 143 are shown. Processing mechanism 110 is illustratively implemented using one or more personal computers, mainframe computers, servers, microprocessor-based devices, or various combinations thereof. Separate elements may be used to implement processing mechanism 110, ingest server 140, and data storage drive 111, or one or more of processing mechanism 110, data storage drive 111, and ingest server 140 could be combined into a single element.

Processing mechanism 110 is capable of accepting input from an input mechanism 193. Input mechanism 193 could, but need not, be implemented using a computer keyboard, touch screen, pushbuttons, one or more switches, voice-activated software, personal computer, computer server, mainframe computer, laptop computer, computer console, or various combinations thereof. In response to input received at input mechanism 193, processing mechanism 10 may command first multicast server 141 to access a stored television program on data storage drive 111 to generate a second multicast program stream including the television program commencing at a first delayed time later than the scheduled broadcast time. This second multicast program stream is shown as second audiovisual signal 116. Illustratively, in response to input received at input mechanism 193, processing mechanism 110 commands second multicast server 142 to access the stored television program on data storage drive 111 to generate a third multicast program stream including the television program commencing at a second delayed time later than the first delayed time. The third multicast program stream is shown as third audiovisual signal 117. Illustratively, in response to input received at input mechanism 193, processing mechanism 110 commands third multicast server 143 to access the stored television program on data storage drive 111 to generate a fourth multicast program stream including the television program commencing at a third delayed time later than the second delayed time. The fourth multicast program stream is shown as fourth audiovisual signal 118.

The television program may be listed in an electronic program guide that associates the program with a specified viewing interval during which the program is available for viewing. The specified viewing interval may, but need not, include a scheduled broadcast time at which the television program is being broadcast live. Illustratively, the difference between the first delayed time and the second delayed time is in an approximate range of thirty to sixty minutes, and the difference between the second delayed time and the third delayed time is approximately equal to the difference between the first delayed time and the second delayed time. The scheduled broadcast time could, but need not, be related to the first delayed time. The foregoing values are provided only as examples, as it should be clearly understood that other values could be employed to meet the requirements of specific system applications.

In response to a viewer request to view the television program during the specified viewing interval, a multicast program stream is selected for which the program has not yet started. The viewer request is received by the viewer first selecting a channel from an electronic program guide, and then selecting an available program for viewing during a specified viewing interval from the electronic program guide. Optionally, if a plurality of multicast program streams are available for which the program has not yet started, a program stream is selected which provides the shortest delay prior to program commencement. During the delay prior to program commencement, optional preprogram material such as advertisements, graphical displays, coming attractions, music, announcements, or various combinations thereof may be presented.

First, second, third, and fourth audiovisual signals 115, 116, 117, 118 each representing streams of individual packets corresponding to respective first, second, third, and fourth multicast program streams pass through a series of routers/switches 130, 131, 132 until one or more of the streams reaches a viewer's location. First, second, third, and fourth audiovisual signals 115, 116, 117, 118 are described only for purposes of illustration, it being understood that four signals are not required, as any number of two or more audiovisual signals may be provided.

At the viewer's location, network interface equipment 160 receives one of the first, second, third, and fourth multicast program streams from router/switch 132 on network 200. Network interface equipment 160 is operatively coupled to a set top box 170 using a wireless or wireline link and, illustratively, using an Ethernet link. Set top box 170 is operatively coupled to a media presentation device 180, such as a television set, video receiver, or the like, using a wireless or wireline link and, illustratively, using coaxial cable carrying an RF-modulated signal. Alternatively or additionally, set top box 170 is coupled to media presentation device using a video connection such as S-Video or FireWire.

Set top box 170 is equipped with a processing mechanism, such as a microprocessor or microcontroller and associated semiconductor memory, for executing an electronic program guide application 171. Electronic program guide application 171 causes media presentation device 180 to display an electronic program guide in the form of a list or menu of one or more programs or channels, wherein at least one of these programs or channels is associated with a corresponding scheduled broadcast time. Set top box 170 includes a channel/program selection mechanism capable of accepting a viewer input identifying one or more channels or programs. This channel/program selection mechanism could, but need not, operate in conjunction with electronic program guide application 171, for example using optional remote control 173 or a touch-sensitive screen on media presentation device 180 to select a displayed program or channel from the displayed electronic program guide. Alternatively or additionally, set top box 170 may include a channel/program selection mechanism such as a rotary switch and/or a channel/program selection mechanism operated using an optional remote control 173. Set top box 170 may, but need not, include circuitry for converting digital packets representing program streams received from network interface equipment 160 into analog or digital signals capable of being displayed on media presentation device 180.

A viewer may record a program for later viewing using a local storage device 181 such as a digital video disc (DVD) recorder, video cassette recorder (VCR), or hard drive recording device. Optional local storage device may, but need not, be integrated into set top box 170. Moreover, set top box 170 may, but need not, be integrated into media presentation device 180.

Network interface equipment 160 receives a stream of internet protocol (IP) multicast or unicast packets representing a program stream. Unicast refers to communication between a single sender and a single receiver, whereas multicast refers to communication between a single sender and multiple receivers. To avoid sending a multiplicity of different program streams simultaneously over network 200, each respective program stream uses a corresponding IP multicast identifier specific to that program stream. Using Internet Group Management Protocol (IGMP), network interface equipment 160 communicates with network 200 to identify which program the user desires to view or is currently viewing. More specifically, when a user enters an input into the channel/program selection mechanism on set top box 170, illustratively using an optional remote control 173, set top box 170 transmits an IGMP join message 185 to the network 200.

IGMP join message 185 includes a channel/program identifier that identifies a channel or program that the viewer desires to view or is currently viewing. IGMP join message 185 is sent in an “upstream” direction through routers/switches 132, 131, 130 in an attempt to locate a program stream on network 200 corresponding to the channel/program identifier. When the appropriate program stream is located, packets bearing a specified multicast identifier 190 for this stream are transmitted in a “downstream” direction from network 200 to network interface equipment 160 and set top box 170. Set top box 170 then relays the program stream to media presentation device 180, such as a program stream representing first audiovisual signal 115 and carrying a first television program at a scheduled broadcast time. Thereafter, when the user enters an input into the channel/program selection mechanism on set top box 170 indicating that he or she wishes to view a second television channel or program, set top box 170 transmits an IGMP leave message 195 to network 200 identifying the first television program, and transmits an IGMP join message 185 to the network 200 identifying the second television channel or program.

As understood by one of ordinary skill in the relevant art, if a program is intended for one and only one subscriber, multicasting is replaced by unicasting. Both multicasting and unicasting fall within the scope of the instant teaching. An example of a unicast program would be a video-on-demand (VOD) program, which by definition is intended for one and only one user destination.

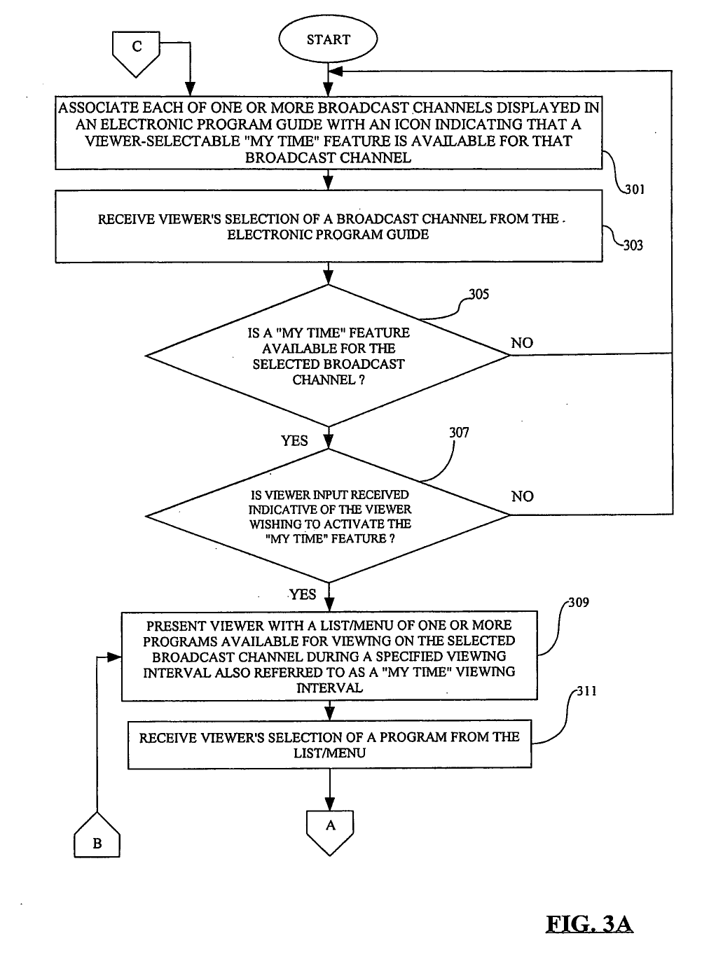

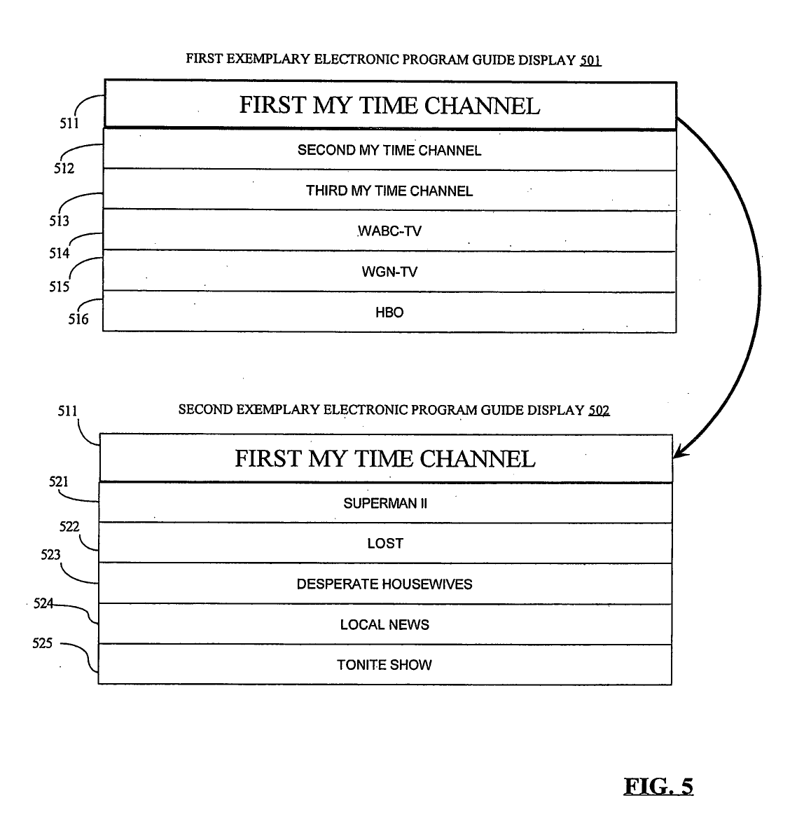

FIG. 2 is a flow diagram of a first exemplary process for delivering one or more television programs for viewing during a specified viewing interval. The process starts at block 201 where a viewer's selection of a broadcast channel is received from an electronic program guide. FIG. 5 is an illustrative electronic program guide showing a list or menu of one or more television programs that are available for viewing on a selected broadcast channel during a specified viewing interval. The electronic program guide includes a channel list or menu setting forth identifying indicia for one or more broadcast channels, such as a description of the channel, a channel name, a channel number, call letters, an icon identifying the channel, or any of various combinations thereof. The one or more channels each offer one or more programs available for viewing concurrently. By way of illustration, a list or menu of available channels on a first exemplary electronic program guide display 501 includes a first My Time channel 511, a second My Time channel 512, a third My Time channel 513, WABC-TV 514, WGN-TV 515, and HBO 516. Each of one or more channels in first exemplary electronic program guide display 501 is associated with an indication, such as an icon 555, indicating that a viewer-selectable “My Time” feature is available for that broadcast channel. Alternatively or in addition to using icon 555, the availability of a “My Time” feature for a given channel may be presented by selecting a feature-descriptive name for the channel, such as first My Time channel 511 or second My Time channel 512. The electronic program guide could, but need not, list one or more additional broadcast channels for which a viewer-selectable “My Time” feature is not available, in which case these one or more additional channels would not be associated with the aforementioned icon 555 or descriptive name, such as WABC-TV 514.

Upon a viewer selecting a channel such as first My Time channel 511, the first exemplary program guide display 501 is replaced or supplanted by a second exemplary electronic program guide display 502. Second exemplary electronic program guide display 502 shows a list or menu of one or more television programs that are available for viewing on the selected first My Time channel 511 during a specified viewing interval. In the present example, these television programs include Superman II 521, Lost 522, Desperate Housewives 523, local news 524, and the Tonite Show 525. The first and second exemplary electronic program guide displays 501 and 502 are generated by electronic program guide application 170 (FIG. 1).

Returning now to FIG. 2, at block 203, the viewer is presented with a list or menu of two or more programs on the selected broadcast channel that are available for viewing during a specified viewing interval. Illustratively, this viewing interval could, but need not, be termed a “My Time” viewing interval. The length of the specified viewing interval may, but need not, be in the approximate range of one hour to twenty-four hours. Next, at block 205, a viewer's selection of a program is received from the list or menu. At block 207, a test is performed to determine whether or not the specified viewing interval has commenced. If not, the process waits (block 210) until the specified viewing interval has commenced, whereupon the process then progresses to block 209.

The affirmative branch from block 207 leads to block 208 where a test is performed to determine whether or not the specified viewing interval has expired. If so, the process loops back to block 201. The negative branch from block 208 leads to block 209 where the selected program is retrieved from a local storage drive, or a program stream produced by encoder 120 (FIG. 1) is joined, or a program stream generated from a program stored in a network storage drive is joined. An example of a network storage drive includes data storage drive 111 (FIG. 1). A local storage drive illustratively includes local storage device 181 (FIG. 1). Optionally, in the case of streaming from a network storage drive or encoder, encoder 120 (FIG. 1) generates a first audiovisual signal 115 including the program starting at a first prescheduled time. Accessing data storage drive 111, first multicast server 141 generates a second audiovisual signal 116 including the program starting at a second prescheduled time later than the first prescheduled time but still within the specified viewing interval. Accessing data storage drive 111, second multicast server 142 generates a third audiovisual signal 117 including the program starting at a third prescheduled time later than the second prescheduled time but still within the specified viewing interval, and third multicast server 143 accesses data storage drive 111 to generate a fourth audiovisual signal 118 including the program starting at a fourth prescheduled time later than the third prescheduled time but still within the specified viewing interval. The program is streamed by any one of the audiovisual signals 114, 115, 116, 117 for which the program has not yet commenced. Optionally, preprogram material such as advertisements or coming attractions is streamed to the viewer prior to program commencement. Illustratively, in some system applications, first audiovisual stream 115 from encoder 120 may not be provided, and only audiovisual streams generated using programs stored in data storage drive 111 are used.

At block 211 (FIG. 2), the selected program is streamed or downloaded to media presentation device 180 (FIG. 1). At block 213, a test is performed to ascertain whether or not the selected program has concluded. If not, the procedure waits at block 215 until the program has concluded. Upon conclusion of the program, the procedure loops back to block 203 where the viewer is presented with a list or menu of two or more available programs on the selected broadcast channel.

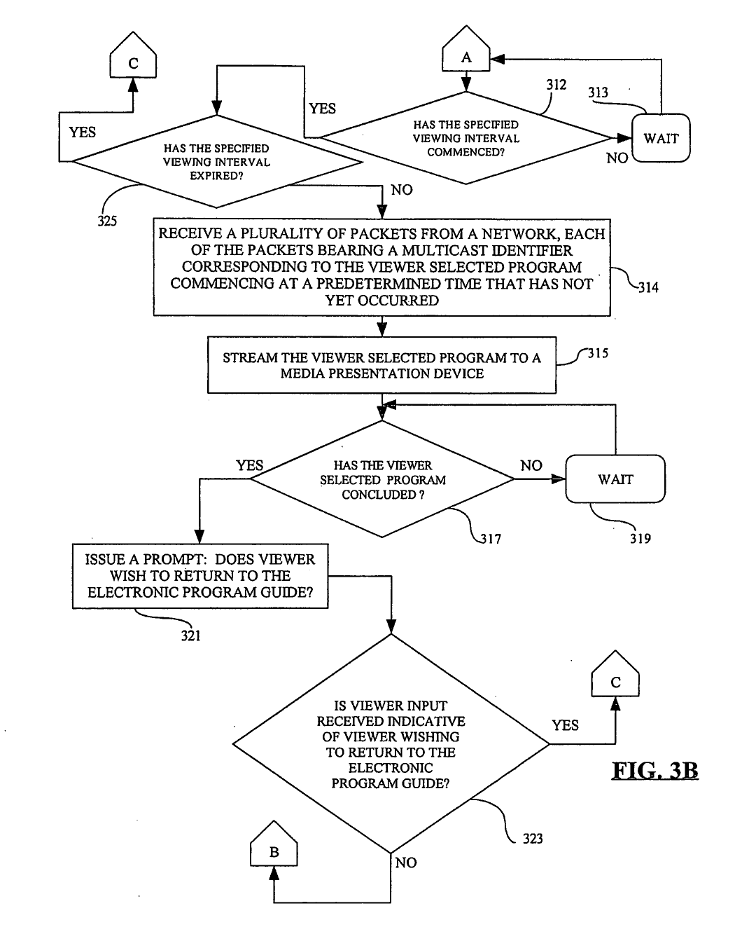

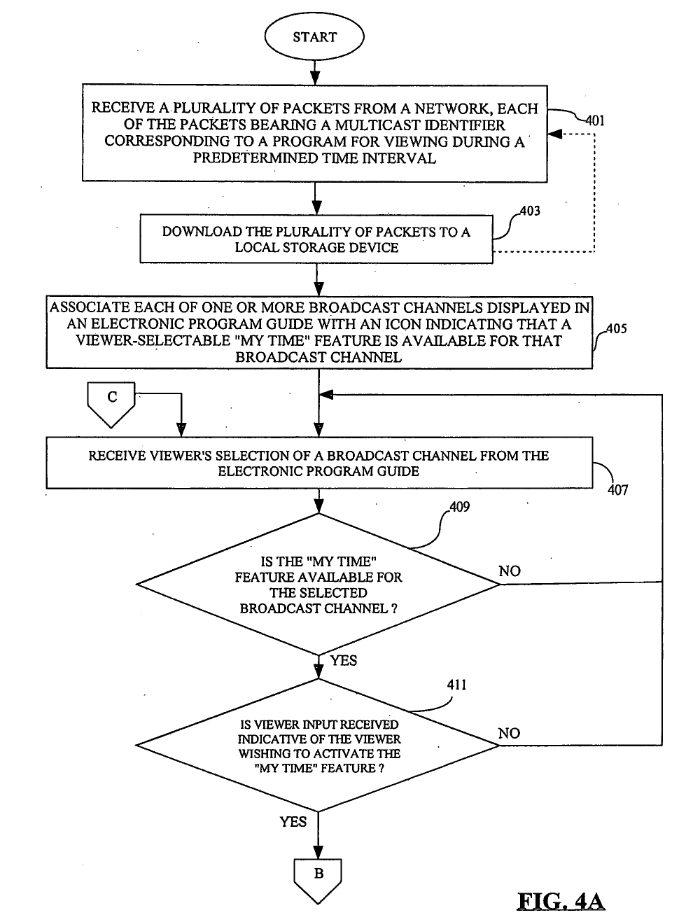

FIGS. 3A and 3B together comprise a flow diagram of an exemplary network-based process for delivering one or more television programs for viewing during a specified viewing interval. The process commences at block 301 where each of one or more broadcast channels in an electronic program guide is associated with an indication, such as an icon 555 (FIG. 5) indicating that a viewer-selectable “My Time” feature is available for that broadcast channel. As shown in first exemplary program guide display 501, the indication of the availability of a “My Time” feature for a given channel is illustratively presented using icon 555, and in some cases by selecting a feature-descriptive name for the channel, such as first My Time channel 511 or second My Time channel 512. However, the indications shown in FIG. 5 are for illustrative purposes only, as other types of indications may be employed, as for example, by listing channels for which the “My Time” feature is available in a different color or graphical font relative to channels for which the feature is not available. The electronic program guide could, but need not, list one or more additional broadcast channels for which a viewer-selectable “My Time” feature is not available, in which case these one or more additional channels would not be associated with the aforementioned icon 555, indication, or descriptive name.

A viewer's selection of a broadcast channel from the electronic program guide is received at block 303 (FIG. 3A). At block 305, a test is performed to ascertain whether or not the “My Time” feature is available for the selected broadcast channel. If not, the process loops back to block 301. The affirmative branch from block 305 leads to block 307 where a test is performed to ascertain whether or not viewer input is received indicative of the viewer wishing to activate the “My Time” feature. If not, the process loops back to block 301. The affirmative branch from block 307 leads to block 309 where the viewer is presented with a list or menu of one or more available programs on the selected broadcast channel. The viewer's selection of a program from the list or menu is received at block 311.

Next, at block 312, a test is performed to ascertain whether or not a specified viewing interval has commenced. The “My Time” feature provides for viewing of the selected program only during the specified viewing interval. This specified viewing interval is defined as including at least one timeslot during which one or more selected programs may be viewed. If the specified viewing interval has not commenced, the process waits at block 313 until the specified viewing interval does commence. The affirmative branch from block 312 leads to block 325 where a test is performed to ascertain whether or not the specified viewing interval has expired. If so, the program loops back to block 301. The negative branch from block 325 leads to block 314 where a plurality of packets are received from a network. Each of the packets bears a multicast identifier corresponding to the viewer selected program commencing at a predetermined time that has not yet occurred. The packets are received in response to transmitting a join message (i.e., IGMP join message 185, FIG. 1) to the network which is indicative of a viewer requesting to view the selected program.

For illustrative purposes, assume that a viewer has activated the “my time” feature in block 307 (FIG. 3A) after the viewer selected program has already commenced on first audiovisual signal 115 (FIG. 1). If first audiovisual signal 115 were to be delivered to the requesting viewer, the viewer would miss the beginning of the program. Accordingly, an audiovisual signal is located on network 200 that includes the viewer selected program commencing at a predetermined time that has not yet occurred. If a respective plurality of audiovisual signals are available which include the viewer selected program commencing at each of a plurality of corresponding predetermined times that have not yet occurred, an audiovisual signal is selected for which the predetermined time is closest to the present time. Optionally, the selected audiovisual signal includes pre-program material in the form of commercial announcements, preprogram material, musical selections, graphical displays, or various combinations thereof.

Assume that second audiovisual signal 116 (FIG. 1) includes the viewer selected program commencing ten minutes after the viewer has activated the “My Time” feature at block 307 (FIG. 3A), whereas third audiovisual signal 117 (FIG. 1) includes the viewer selected program commencing twenty minutes after the viewer has activated the “My Time” feature, and fourth audiovisual signal 118 includes the viewer selected program commencing an hour after the viewer has activated the “My Time” feature. Accordingly, second audiovisual signal 116 includes the viewer selected program commencing at a predetermined time closest to the present time. At block 314 (FIG. 3B), a program stream on network 200 (FIG. 1) is joined that includes the viewer selected program to commence subsequently. Pursuant to the present example, a plurality of packets are received from the stream wherein each of the packets bears a multicast identifier corresponding to second audiovisual signal 116. These packets are received at network interface equipment 160 and set top box 170.

Next, at block 315 (FIG. 3B), the viewer selected program is streamed to media presentation device 180 (FIG. 1). At block 317 (FIG. 3B), a test is performed to ascertain whether or not the viewer selected program has concluded. If not, the process waits at block 319 until the viewer selected program has concluded. The affirmative branch from block 317 leads to block 321 where a prompt is issued asking the viewer whether he or she wishes to return to the electronic program guide. At block 323, a test is performed to ascertain whether or not an input from the viewer is received indicative of the viewer wishing to return to the electronic program guide. If so, the process loops back to block 301 (FIG. 3A). The negative branch from block 323 (FIG. 3B) leads to block 309 (FIG. 3A, described previously).

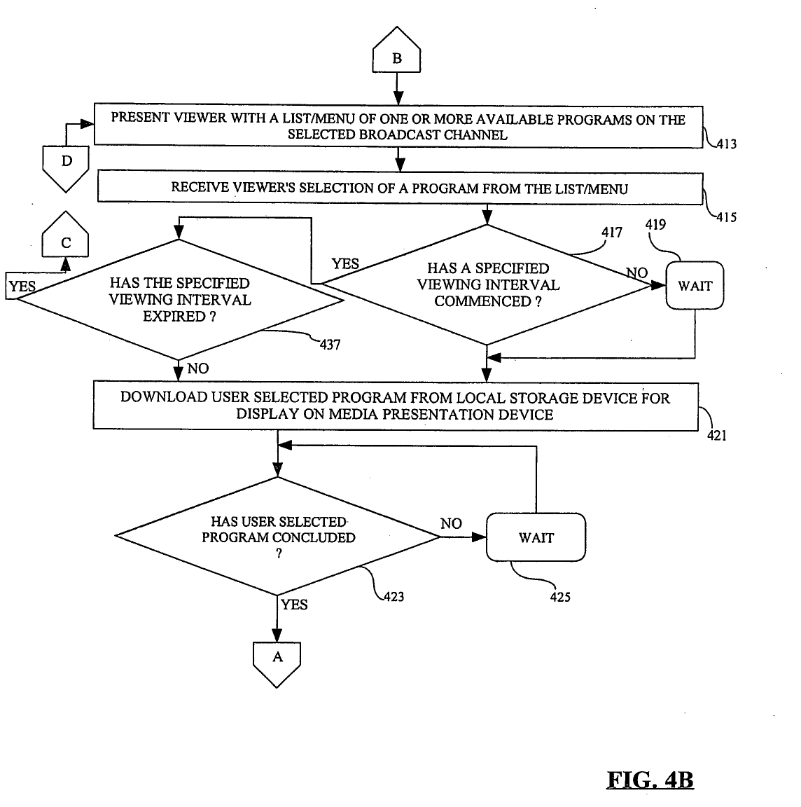

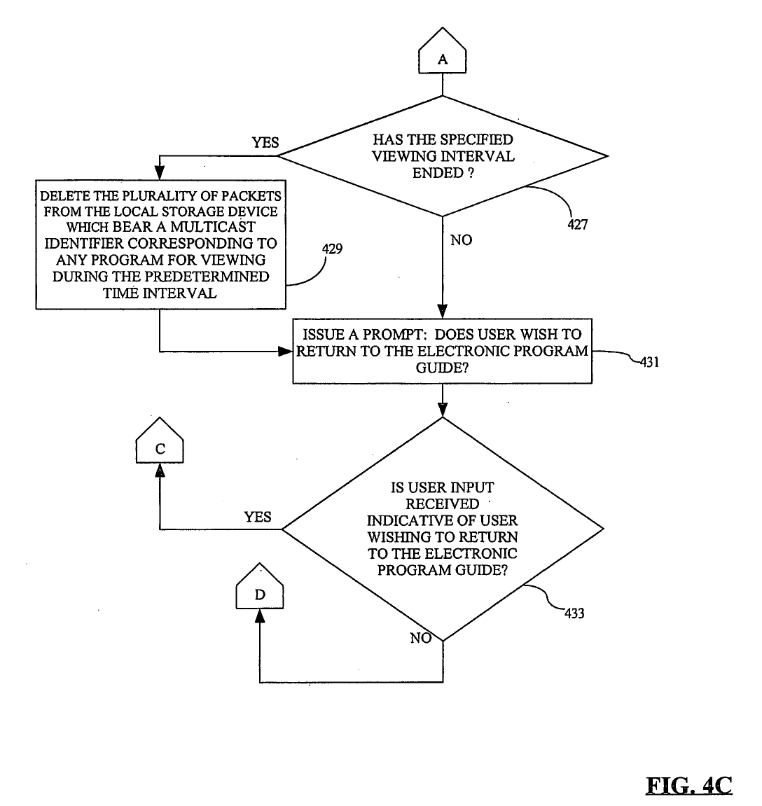

FIGS. 4A and 4B together comprise a flow diagram of an exemplary premises-based process for delivering one or more television programs for viewing during a specified viewing interval. The process commences at block 401 (FIG. 4A) where a program stream is joined on network 200 (FIG. 1) to receive a plurality of packets, each of the packets bearing a multicast identifier corresponding to a program for viewing during a predetermined time interval. This predetermined time interval may be conceptualized as a “My Time” viewing interval during which a viewer can select one or more programs for viewing from a menu or list on an electronic program guide. If the viewer selects a plurality of programs for viewing, the viewer is able to watch the programs in a viewer-specified sequence. At block 403, the plurality of packets are streamed to a local storage device. After block 403 (FIG. 4A) is performed, the program optionally loops back to block 401 where a second stream is joined to receive a second plurality of packets from the network, each of the plurality of packets bearing a multicast identifier corresponding to a second program for viewing during the predetermined time interval. The program then advances to block 403 where the second plurality of packets is streamed to the local storage device. Optionally, blocks 401 and 403 may be repeated any number of times to download any number of programs from the network to the local storage device.

After one or more programs are downloaded from the network to the local storage device at blocks 401 and 403 (FIG. 4A), each of one or more broadcast channels is displayed in an electronic program guide with an icon indicating that a viewer-selectable “My Time” feature is available for that broadcast channel (block 405). The viewer's selection of a broadcast channel from the electronic program guide is received (block 407). Next, a test is performed to ascertain whether or not the “My Time” feature is available for the selected broadcast channel. If not, the procedure loops back to block 407. The affirmative branch from block 409 leads to block 411 where a test is performed to ascertain whether or not a viewer input is received indicative of the viewer wishing to activate the “My Time” feature. If not, the procedure loops back to block 407. The affirmative branch from block 411 leads to block 413 (FIG. 4B) where the viewer is presented with a list or menu of one or more available programs offered on the selected broadcast channel during a specified viewing interval referred to as a “My Time” interval.

The viewer's selection of a program from the list or menu is received at block 415. A test is performed at block 417 to ascertain whether or not the specified viewing interval has commenced. If not, the procedure waits at block 419 for the specified viewing interval to commence. The affirmative branch from block 417 leads to block 437 where a test is performed to ascertain whether or not the specified viewing interval has expired. If so, the process loops back to block 407. The negative branch from block 437 leads to block 421 where the user selected program is downloaded from local storage device 181 (FIG. 1) for display on media presentation device 180. At block 423 (FIG. 4B), a test is performed to ascertain whether or not the user selected program has concluded. If not, the procedure waits at block 425 until the user selected program has concluded. The affirmative branch from block 423 loops back to block 413 (discussed previously).

The detailed description explains various exemplary embodiments, together with advantages and features, by way of example with reference to the drawings. As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for delivering one or more television programs for viewing during a specified viewing interval, the method including:
receiving a viewer's selection of a broadcast channel from a program guide,
presenting the viewer with a list or menu of two or more programs on the viewer selected broadcast channel that are available for viewing during a specified viewing interval, and
receiving a viewer's selection of a program from the list or menu;
wherein, if the specified viewing interval has commenced and has not yet expired, the viewer selected program is delivered for viewing.

2. The method of claim 1 further including at least one of downloading or streaming the delivered program to a media presentation device.

3. The method of claim 1 further including accessing the computer readable storage medium over a network.

4. The method of claim 1 further including accessing the computer readable storage medium from a local storage drive at a viewer premises.

5. The method of claim 3 further including streaming the viewer selected program to a local storage drive at a viewer premises prior to the specified viewing interval.

6. The method of claim 2 wherein at least one of downloading or streaming the delivered program also includes at least one of downloading or streaming pre-program material to the media presentation device.

7. The method of claim 6 wherein the pre-program material includes any of: an advertisement, an informational announcement, a coming attraction, a graphical display, a pictorial display, musical programming, a corporate logo, or various combinations thereof.

8. An apparatus for delivering one or more television programs for viewing on a media presentation device during a specified viewing interval, the apparatus including an input mechanism for accepting a viewer's selection of a broadcast channel from a program guide, a display operatively coupled to the input mechanism for displaying a list or menu of two or more programs on the viewer selected broadcast channel that are available for viewing during a specified viewing interval, and a processing mechanism for controlling the display;
wherein the input mechanism is capable of receiving a viewer's selection of a program from the displayed list or menu such that, if the specified viewing interval has commenced and has not yet expired, the processing mechanism delivered the viewer selected program for viewing.

9. The apparatus of claim 8 wherein the processing mechanism is capable of at least one of downloading or streaming the delivered program to a media presentation device.

10. The apparatus of claim 8 wherein the processing mechanism is capable of accessing the computer readable storage medium over a network.

11. The apparatus of claim 8 wherein the processing mechanism is capable of accessing the computer readable storage medium from a local storage drive at a viewer premises.

12. The apparatus of claim 10 wherein the processing mechanism is capable of at least one of downloading or streaming the viewer selected program to a local storage drive at a viewer premises prior to the specified viewing interval.

13. The apparatus of claim 9 wherein the processing mechanism is capable of at least one of downloading or streaming pre-program material to the media presentation device

14. The apparatus of claim 13 wherein the pre-program material includes any of: an advertisement, an informational announcement, a coming attraction, a graphical display, a pictorial display, musical programming, a corporate logo, or various combinations thereof.

15. A computer program product for delivering one or more television programs for viewing during a specified viewing interval, the computer program product comprising instructions for:
receiving a viewer's selection of a broadcast channel from a program guide,
presenting the viewer with a list or menu of two or more programs on the viewer selected broadcast channel that are available,for viewing during a specified viewing interval, and
receiving a viewer's selection of a program from the list or menu;
wherein, if the specified viewing interval has commenced and has not yet expired, the viewer selected program is delivered for viewing.

16. The computer program product of claim 15 further including instructions for at least one of downloading or streaming the delivered program to a media presentation device.

17. The computer program product of claim 15 further including instructions for accessing a computer readable storage medium over a network.

18. The computer program product of claim 15 further including instructions for accessing a computer readable storage medium from a local storage drive at a viewer premises.

19. The computer program product of claim 17 further including instructions for at least one of streaming or downloading the viewer selected program to a local storage drive at a viewer premises prior to the specified viewing interval.

20. The computer program product of claim 16 further including instructions for downloading pre-program material to the media presentation device.
